(19) United States
(12) Patent Application Publication
(10) Pub. No.: US 2009/0208686 A1
(43) Pub. Date: Aug. 20, 2009

(54) 3D Bevel Sticky Note Pad

(76) Inventor: Wen-Chen Ho, Taipei City (TW)

Correspondence Address: FRENKEL & ASSOCIATES, 3975 UNIVERSITY DR., STE. 330, FAIRFAX, VA, 22030, US

(21) Appl. No.: 12/031,278

(22) Filed: Feb. 14, 2008

(51) Int. Cl. B32B 33/00

(52) U.S. Cl. 428/40.1

(57) ABSTRACT

The present invention discloses a 3D bevel sticky note pad, which comprises a plurality of stacked sheet papers with an adhesive portion formed on one side of each sheet paper and between each two neighboring sheet papers. All the sheet papers have identical figures at identical locations. The sheet papers respectively have different lengths from the adhesive portions, and the lengths sequentially increase top down to form a beveled face on the other side of the adhesive portions, and the figures are continuous from the topmost sheet paper to the beveled face. Thereby, the 3D bevel sticky note pad of the present invention has a superior visual effect.

### FIELD OF THE INVENTION

The present invention relates to a sticky note pad, particularly to a 3D bevel sticky note pad.

### BACKGROUND OF THE INVENTION

With the population of education and the development of commerce and industry, students or employees have widely used sticky notes or the likes to draft study notes or write down the miscellaneous incidents. The sticky note is commonly a square or rectangle of paper having a strip of low-tack adhesive on its edge, and the squares or rectangles of paper are stacked neatly and glued with the low-tack adhesive to form a pad.

Some sticky notes have undertone figures to achieve an aesthetic effect or have light-color words and obtain an advertising function without interfering with writing and reading.

However, the conventional sticky notes are so similar and only have tiny variations in the figures, shapes and dimensions thereof. Therefore, how to design a novel sticky note and make it outstand from multitudinous products of sticky notes is a common topic concerned by the manufacturers.

A R.O.C patent Publication No. M249820 disclosed “Notes with a 3d Ornamental Advertisement”, wherein figures are presented on a beveled face. As to the fabrication process of the conventional note pad, sheet papers are firstly neatly stacked into a pad in a paper-neatening step. Next, one side of the pad is immersed into a glue, and the edges of the sheet papers are thus joined together. To fabricate a sticky note pad, a readherable sticky film is firstly applied onto one edge of each sheet paper. Thus, the stacked sheet papers are hard to be neatened. Therefore, the fabrication of the beveled face of a sticky note pad is more complicated, which is the reason why a sticky note pad having a 3D beveled face has not appeared in the market yet.

### SUMMARY OF THE INVENTION

The primary objective of the present invention is to provide a 3D bevel sticky note pad, wherein one side of a sticky note pad is cut into a beveled face, and the beveled face has figures, patterns or advertising words to present a size-enlargement impression, a gradient effect and a vivid stereo sensation; decreasing the sheets of the 3D bevel sticky note pad will not influence the integrality of the figures, patterns or advertising words. Thus, the present invention provides a useful, advertising and aesthetic 3D bevel sticky note pad.

To achieve the abovementioned objective, the present invention proposes a 3D bevel sticky note pad, which comprises a plurality of stacked sheet papers with an adhesive portion formed on one side of each sheet paper and between each two neighboring sheet papers. Each sheet paper has identical figures on the corresponding positions. The sheet papers respectively have different lengths from the adhesive portions, and the lengths sequentially increase top down to form a beveled face on the other side of the adhesive portions. The edge of the lower sheet paper protrudes from the edge of the neighboring upper sheet paper. The revealed figure of each sheet paper is continuous to the revealed figures of the neighboring sheet papers on the beveled face. Thereby, the 3D bevel sticky note pad of the present invention has a superior visual effect.

### BRIEF DESCRIPTION OF THE DRAWINGS

FIG. 1 is a diagram schematically showing a 3D bevel sticky note pad according to a preferred embodiment of the present invention.

FIG. 2 is another diagram schematically showing a 3D bevel sticky note pad according to a preferred embodiment of the present invention.

FIG. 3 is a diagram schematically showing a 3D bevel sticky note pad according to another preferred embodiment of the present invention.

### DETAILED DESCRIPTION OF THE PREFERRED EMBODIMENTS

Below, the technical contents of the present invention will be described in detail in cooperation with the drawings.

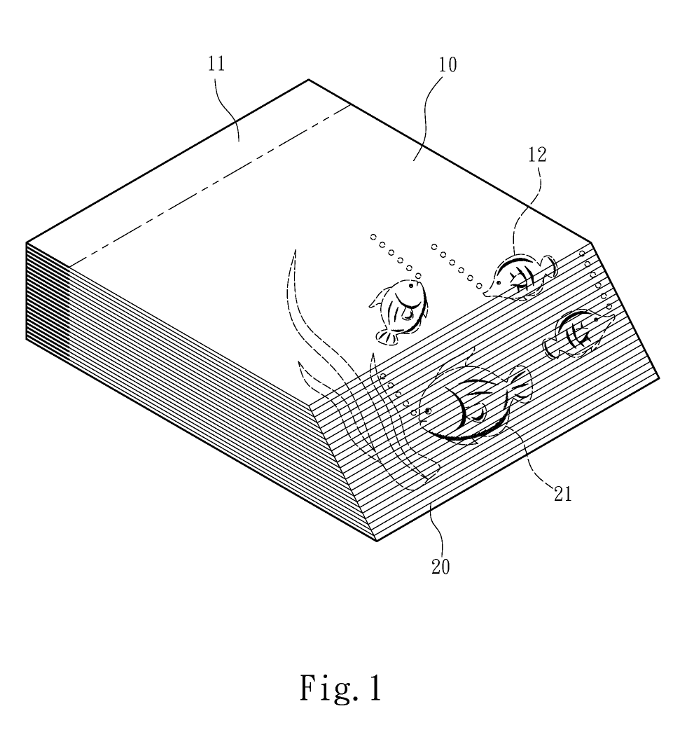

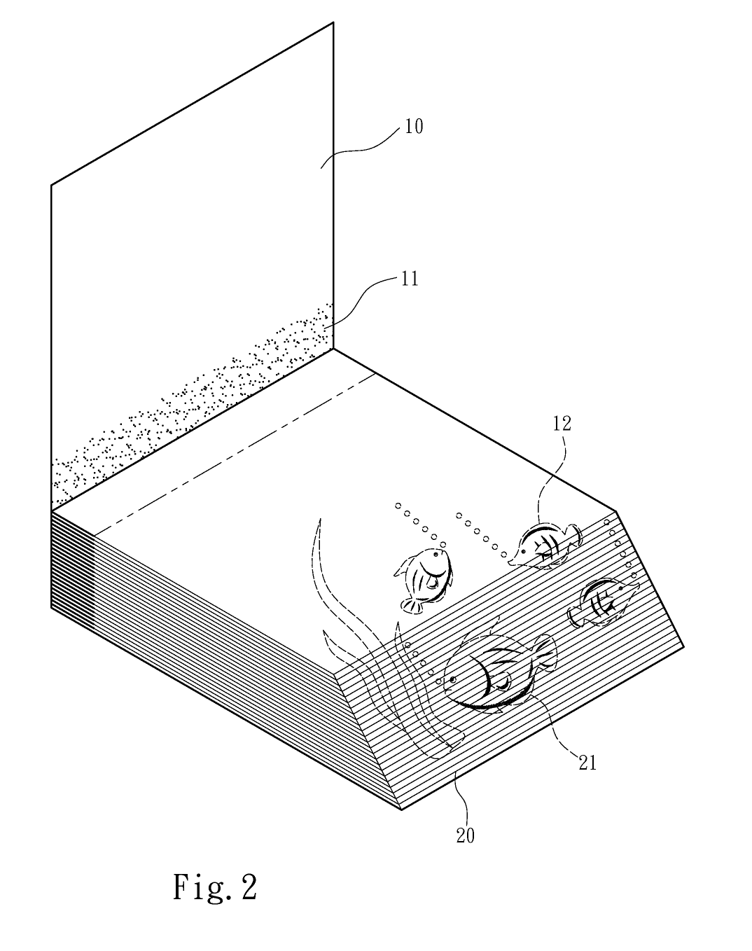

Refer to FIG. 1 a diagram schematically showing a 3D bevel sticky note pad according to a preferred embodiment of the present invention. The present invention proposes a 3D bevel sticky note pad, which comprises a plurality of stacked sheet papers 10 with an adhesive portion 11 formed on one side of each sheet paper 10 and between each two neighboring sheet papers 10. The adhesive portion 11 is repeatably detachable and readherable. Refer to FIG. 2. The user may write a note on one sheet paper 10 and peel off the sheet paper 10 to post it on an appropriate place. All the sheet papers 10 have identical figures at identical locations.

The sheet papers 10 respectively have different lengths measured from the adhesive portions 11. The lengths of the sheet papers 10 sequentially increase top down by a given increment, and the face opposite to the adhesive portions thus becomes a beveled face 20. The edge of the lower sheet paper 10 protrudes from the edge of the neighboring upper sheet paper 10. The FIG. 21 revealed on the edge of one sheet paper 10 is continuous to the FIGS. 21 revealed on the edges of the neighboring two sheet papers 10, and the FIG. 12 on the topmost sheet paper 10 is also continuous to the FIG. 12 on the beveled face 20. Thus, the figures are continuous from the topmost sheet paper 10 to the beveled face 20. The FIGS. 12 and 21 are not limited to but may be patterns, decorative designs or advertising words.

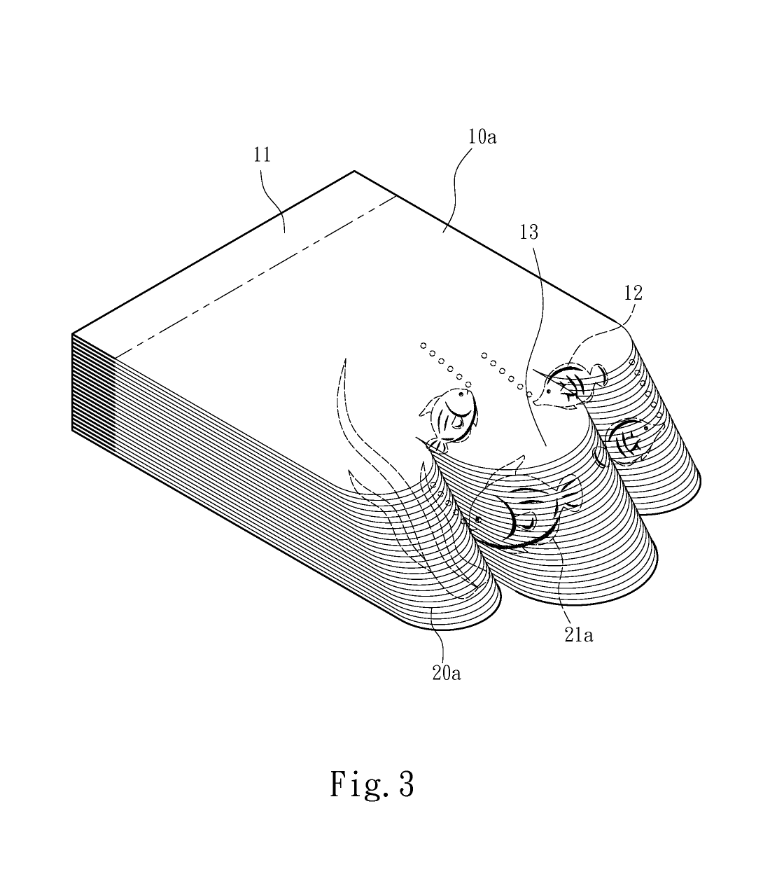

Refer to FIG. 3 a diagram schematically showing a 3D bevel sticky note pad according to another preferred embodiment of the present invention. As shown in FIG. 3, in the 3D bevel sticky note pad of the present invention, the beveled face 20 opposite to adhesive portions 11 is not limited to the planar beveled face 20 described in the preceding embodiment but may also be a beveled face 20a having a plurality of arc portions 13. The technical means of forming the FIGS. 21a on the beveled face 20a is similar to that of the preceding embodiment and will not be repeated here.

The present invention proposes a 3D bevel sticky note pad, wherein one side of a pad of sheet papers 10 is cut into a beveled face 20, and the beveled face 20 has pictures, patterns or advertising words to present a size-enlargement impression, a gradient effect and a vivid stereo sensation; decreasing the sheets of the 3D bevel sticky note pad will not influence the integrality of the figures. In comparison with the conventional sticky note pad, the 3D bevel sticky note pad of the present invention has a superior visual effect and can provide an advertising function and an aesthetic experience.

Those described above are the preferred embodiments to exemplify the present invention. However, it is not intended to limit the scope of the present invention. Any equivalent modification and variation according to the spirit of the present invention is to be also included within the scope the present invention.

What is claimed is:

1. A 3D bevel sticky note pad, comprising a plurality of stacked sheet papers with a readherable adhesive portion formed on one side of each said sheet paper and between each two neighboring said sheet papers, and characterized in
that said sheet papers have identical figures at identical locations, and
that said sheet papers respectively have different lengths from said adhesive portions, and
that said lengths sequentially increase top down to form a beveled face on the other side of said adhesive portions, and
that the edge of said sheet paper placed below protrudes from the edge of said sheet paper placed above, and
that said figures revealed on the edge of said sheet paper placed below is continuous from said figures revealed on the edge of said sheet paper placed above.

2. The 3D bevel sticky note pad according to claim 1, wherein said figures are patterns or decorative designs.

3. The 3D bevel sticky note pad according to claim 1, wherein said figures are written words.

4. The 3D bevel sticky note pad according to claim 1, wherein said lengths of said sheet papers sequentially increase top down by a given increment.
